(19) United States
(12) Patent Application Publication
(10) Pub. No.: US 2023/0146918 A1
(43) Pub. Date: May 11, 2023

(54) SYSTEM AND METHOD FOR FOUR-DIMENSIONAL E-COMMERCE AND INTERCONNECTIVITY

(71) Applicant: Revolution Media, Inc., Wilmington, DE (US)

(72) Inventor: Tyler Miller, Solana Beach, CA (US)

(73) Assignee: Revolution Media, Inc., Wilmington, DE (US)

(21) Appl. No.: 17/802,598

(22) PCT Filed: Mar. 12, 2021
(86) PCT No.: PCT/US2021/022039

§ 371 Date: Aug. 26, 2022

Related U.S. Application Data
(60) Provisional application No. 62/990,733, filed on Mar. 17, 2020.
(60) Provisional application No. 62/988,758, filed on Mar. 12, 2020.
(60) Provisional application No. 62/988,777, filed on Mar. 12, 2020.

(51) Int. Cl. G06Q 30/0601; G06T 19/00; G06Q 20/32; G06Q 20/36; G06F 3/04815; G06F 3/04817

(52) U.S. Cl. CPC G06Q 30/0643; G06T 19/006; G06Q 20/3267; G06Q 20/36; G06F 3/04815; G06F 3/04817

(57) ABSTRACT

A system for four-dimensional e-commerce and interconnectivity has a mobile device, an API server, a catalogue management tool, and a database. The mobile device has a user interface configured to present consumable content having at least four dimensions on a display having two dimensions. The user interface has an interactive spherical icon associated with the consumable content.

### 1. FIELD OF THE INVENTION

The present application relates in general to the field of navigational tools in e-commerce.

### 2. DESCRIPTION OF RELATED ART

Conventional navigational tools in e-commerce present data in a flat display. The navigational tools utilize two-dimensional displays to provide access to consumer content. Digital marketplaces use these navigational tools to visually manage access to large quantities of consumer content, including products and services.

Flat displays are not only aesthetically displeasing, they require multiple display screens to display second tier content that is only accessed through scrolling, tabs, links, or other two-dimensional manipulations. By accessing the second tier of content, the user must leave the display of the first content tier.

Thus, there exists significant room for improvement in the art for overcoming these and other shortcomings of e-commerce navigational tools, user interfaces, and the presentation of enterprise data.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a block diagram of an e-commerce and interconnectivity system;

FIG. 2 is a time-sequence diagram of a method performed by the e-commerce and interconnectivity system shown in FIG. 1;

FIG. 3 is a block diagram of a catalogue management tool;

FIG. 4 is a screen shot of a mobile device with a navigational tool interface;

FIG. 5 is a screen shot of a navigational tool interface after interaction with the interface shown in FIG. 4;

FIG. 6 is a screen shot of a mobile device with a navigational tool interface;

FIG. 7 is a screen shot of a navigational tool interface after interaction with the interface shown in FIG. 6;

FIG. 8 is a block diagram of a prior art catalogue management tool;

FIG. 9 is a block diagram of a catalogue management tool according to aspects of the present invention;

FIG. 10 is a block diagram of a catalogue management tool according to aspects of the present invention;

FIG. 11 is a block diagram of a client board according to aspects of the present invention;

FIG. 12A is a block diagram of database sub-system including a content writer;

FIG. 12B is a block diagram of a buffer shown in FIG. 12A;

FIG. 13 is a content entry generated by the content writer shown in FIGS. 12A and 12B;

FIG. 14 is a product linked to the catalogue management tool;

FIG. 15 is a method for connecting a catalogue management tool; and

FIG. 16 is a method for enabling an application mode of an API server.

While the assembly of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method for four-dimensional e-commerce and interconnectivity with features including versatile content presentation, adjustability, adaptability, and unhindered cataloguing for e-commerce are provided below. It will of course be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

“Client dimension” as used herein means the interface at which a user or player manipulates displayed content on a mobile device or a client device, such as a smart phone, tablet, virtual reality (VR) headset, or an augmented reality (AR) headset.

“Key, balance, and service (KBS) validator” as used herein means programmable or executable computer instructions housed in either a physical or virtual machine to perform the processes of validating financial data, software as a service (SaaS) authorized use, and authorized API use from the client dimension.

The present invention provides improvements to e-commerce navigational tools, user interfaces, and the presentation of enterprise data including: enabling the client dimension to control the interactive content delivery process; the client dimension is configured to let the user browse upon various media; the client dimension is configured to transition from a multi-paneled or gridded spherical experience to a unique piece of content that has been algorithmically simulated to populate a portion of a sphere; the client dimension is configured to pull the sphere around (the sphere rolls) and content actively adapts to the optimal aspect ratio for a user to consume content; the client dimension is configured to zoom closer toward the spherical object and the content on the object and out to see the sphere from an optimal view; the client spherical frame is configured to control the interactive zoom and 360 degree scrolling; the client frame is configured to control the interactive spherical experience and content delivery from inside of a sphere in virtual reality—gyroscope and interactive browsing from inside the sphere, content populated by algorithmic command inside the sphere is optimally preferred and conveyed for the user to click or engage in consuming that content via full screen; the client frame is configured to control the interactive enterprise nucleus of spherical content integration; the client frame is configured to control the interactive process of scrolling across an optimally content populated sphere and purchasing a product; and the client frame is configured to control a premier and optimal way to deliver mass amounts of content.

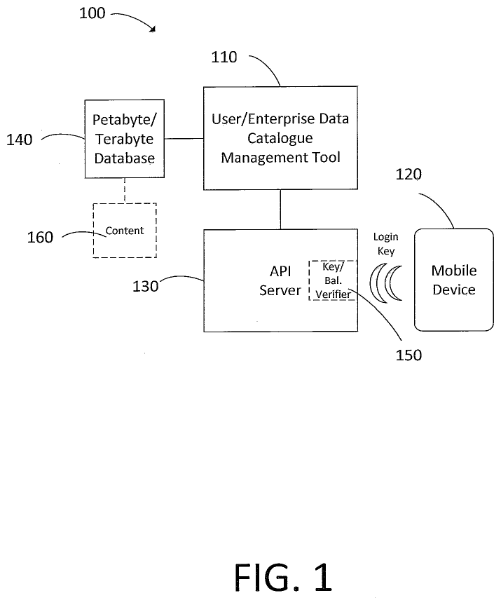

Referring to FIG. 1 in the drawings, a system 100 for four-dimensional e-commerce and interconnectivity is illustrated. System 100 includes user/enterprise data catalogue management tool (CMT) 110, a mobile client device 120, an API device 130, such as a server, a multi-petabyte or multi-terabyte database 140, and a KBS verifier 150. System 100 writes customer account information in/on at least one of a virtual/physical address location (VPAL) or receipt 160 and stores the VPAL or receipt 160 in a manner that can be easily stored, tracked, and located.

CMT 110 and API server 130 are connected together using wired network connections, such as twisted pair, Ethernet, fiber optics, Cat5, Cat6, or similar network connections. Database 140 is connected to CMT 110 using a network connection. Mobile device 120 is connected to CMT 110 and API server 130 over a mobile or a wireless network connection. Mobile and wireless network connections are established through base stations, broadband modems, switched telephone networks, routers, and the Internet using established procedures and communication protocols, including, but not limited to, TCP/IP, IPv4, and IPv6.

The login key is provided by mobile device 120 to the KBS verifier 150, and includes but is not limited to, a password, a biometric key, a unique image, video, or audio file, a three-dimensional (3D) quick response (QR) code, encrypted RF signal, or combinations thereof. The login key is used to connect catalogue transactions occurring on a mobile device with a specific and unique software as a service (SaaS) system machine maintained by a merchant or an enterprise. In an alternative embodiment, KBS verifier 150 is a software portion, application, or programmed feature of mobile device 120.

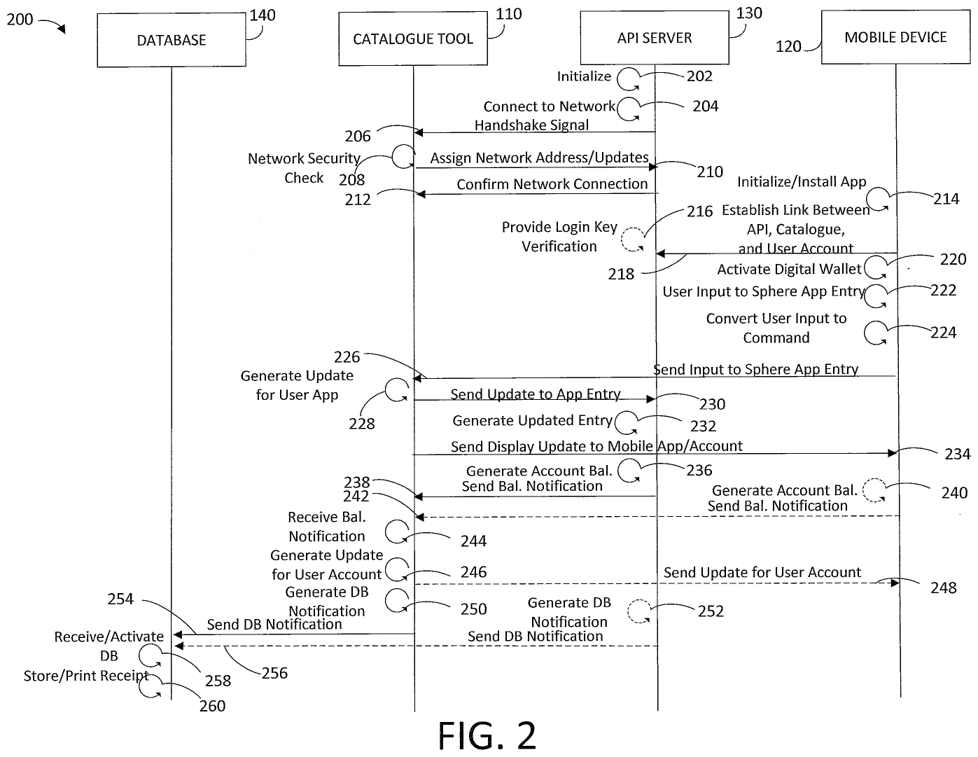

Referring now also to FIG. 2 in the drawings, system 100 uses method 200 to modify, store, log, or print catalogue account information in a database as a retrievable VPAL or receipt 160. Step 202 of method 200 includes initializing an API server in a retail environment, such as a merchant business location, an online marketplace, or a proxy service provider. For example, API server 130 is powered on, initialized, and port connectors connected.

Step 204 includes connecting the API server 130 to the catalogue network. For example, CMT 110 may be configured to use an Ethernet protocol, a Serial Attached SCSI (SAS) point-to-point communication protocol, and/or additional communication protocols. Step 204 further includes configuring API server 130 to communicate with CMT 110 according to the appropriate one or more protocols. API server 130 is further configured to utilize machine learning, SQL functions, and other features available by a service such as Microsoft Azure.

Step 206 includes sending a low power or low bandwidth communication signal to the catalogue network. For example, API server 130 sends a handshake signal to CMT 110, requesting access to the network.

Step 208 includes performing a network security check and connecting the API server to the catalogue network based on the result of the security check. For example, step 208 includes checking tables for appropriate source, destination, or MAC addresses. Step 208 may also include checking the frequency of attempts to establish the network connection.

Step 210 includes granting the API server access to the catalogue network. For example, step 210 includes assigning an IP or subnet address, sending the address(es) to the API server, and connecting the API server to the intranet of the establishment and the catalogue network. Because API server 130 may previously have been in storage, in at least one embodiment, step 210 further includes providing updates, including firmware updates, to API server 130 after the network connection is established.

Step 212 includes sending a signal to confirm that the network connection is established. For example, API server 130 sends a signal to CMT 110 over a newly established network connection. CMT 110 receives the signal over the newly established network connection, confirming proper setup.

Step 214 includes installing and initializing a user interface (UI) onto a mobile device capable of displaying a four-dimensional interface in a two-dimensional format. For example, mobile device 120 is user-controlled and operated, requiring the user to access a database and download the necessary UI to purchase products based on friend recommendations, status of the product (e.g., viral), and business/merchant recommendations according to similarly related content. In an alternative embodiment, step 216 includes employees or individuals of the API server establishment pre-installing the necessary UI on establishment-owned, user-controlled mobile devices, such that customers entering the establishment are provided with a pre-installed mobile device to make purchases within the establishment.

Step 216 includes providing a login verification from the KBS verifier 150. After a user provides the login credentials, the API server 130 verifies the credentials are correct.

In an alternative embodiment, the login key is an audio or image file provided by the API server 130, received by the mobile device 120, and returned by mobile device 120 to the API server 130 with a private key stored by the mobile device 120. This alternative embodiment makes providing/displaying the login key verification optional. In yet another embodiment, step 214 further includes providing an amount associated with a catalogue entry, such as the price of a widget or the price of a cog.

Step 218 includes establishing a link between the API server, the mobile device and the user's account to conduct financial, consumer transactions via the UI installed on the mobile device that affect the products and balances displayed on the UI.

In an alternative embodiment, at least two links are established between the API server and two different mobile devices. For example, two users each having their separate mobile devices with separate customer accounts on each, such as a husband and wife, may wish to pool funds from the separate accounts to increase establishment tab/credits available to them.

Step 218 further includes generating and rendering a display screen indicator to show that an active link between the API server and a mobile device has been established. This indicator may help prevent customers from attempting to make purchases without actually purchasing or consuming catalogue content.

Step 220 includes activating the digital wallet of a user device in a merchant establishment where a purchase is to be made. For example, the mobile device 120 may have the merchant icon/logo and/or products displayed on The Sphere, which receives user input through activation of icon/logo displayed on The Sphere (e.g., an active spherical icon of the UI). The user input automatically activates the account balance, or user's credit tab, on the mobile device associated with the merchant. In other embodiments, the account balance is proximity-based, meaning upon entry into the establishment the user's credit/tab at the store is displayed and all the products associated with the merchant are displayed at distinct spherical coordinates of The Sphere as interactive icons.

Step 222 includes manipulating a user-interactive element, such as a sphere-shaped icon, using the UI displayed on the mobile device 120. For example, after download, installation, and activation, users will be brought to the interface which will feature the Sphere. Users will be able to manipulate the Sphere which is populated with content, such as merchant-generated or enterprise-generated content, to find the content and consume. Each individual piece of content, whether picture or video, will be displayed on the exterior of the sphere using an automated content population algorithm. The shapes and sizes of the content in the grid will be displayed in different sizes and manner based on the type of content, and size. Once a piece of content is clicked on, it will enter into the content consumption mode and can be exited back to the Sphere using touch gestures.

Step 224 includes converting user input or manipulation received to the display screen of mobile device 120 to a command, thereby enabling the user to begin the consuming content active mode. Consuming content active mode includes access, manipulation, interconnectivity, socializing, status, and purchasing capabilities. For example, step 224 may include KBS verifier 150 verifying the purchased product is within constraints set by the establishment, where the verification is displayed in a conspicuous location on the display. For instance, if the amount associated with multiple products being purchased does not exceed the credit limit of the merchant, then the key/balance verifier verifies that the purchase may be made.

Step 224 includes obtaining an encryption key to access catalogue content. For example, upon pressing an active icon of the UI, The Sphere application is configured to access memory, either on the mobile device or the API server, to retrieve a private encryption key required to access the catalogued content. The processor of the API device, such as a desktop computer, automatically processes mobile device and product identifiers, such as MAC addresses, hashtags, and corresponding table entries, associated with the private key and the merchant.

Step 224 includes generating an API or database command based on the user input at the mobile device to further manipulate the catalogue consumable content. For example, the user may make several purchases of the same product, may “like”, comment on the quality, or send a video related to the consumable content or product. Each user input is received and converted into a command to update the catalogue API and/or database.

Step 226 includes sending the catalogue transactions and/or commands from the mobile device to the catalogue network. For example, mobile device 120 may send a packet of information, with the payload containing transactional data, such as a merchant account credit, to CMT 110.

Step 228 includes receiving the packet including the transactional data and generating an update to the catalogue, merchant, and/or user account. For example, CMT 110 may generate a decreased or increased credit/tab for the user operating mobile device 120.

Step 228 further includes generating an account update for API server 130. The account update includes an increase or a decrease to the default balance, credit, or tab displayable on either the API device or the mobile device 120.

Step 230 includes sending the account update to API server 130. For example, a packet of information including the account updates are sent to the desktop computer or controller for API server 130. By way of another example, if the Ethernet connection is down or not functioning, the account updates may be sent using the Serial SCSI Protocol (SSP).

Step 232 includes receiving, at API server 130, the account update from CMT 110. The receipt of the update triggers a display of the updated account on a display associated with API server 130.

Step 234 includes sending the account update to the mobile device such that the merchant-associated account displayed on the mobile device represents a current account balance. This step is nearly simultaneous with step 232. For example, as soon as an administrator sees the update at API server 130, such as a decrease to the balance as a result of a purchase transaction, almost immediately thereafter or at the same time, mobile device 120 receives the account update from CMT 110 to update the display of the merchant account balance for the operator of the mobile device 120.

Step 236 includes receiving user input at the API server to terminate a user account. For example, a merchant may be going out of business, such that an API server 130 may generate a termination and/or balance available notification. This notification will signal to the user that the user's balance must be paid, has been paid, or amounts are available for collection by the user.

Step 236 further includes generating a transmission for sending the notification. For example, a packet header includes metadata, such as header length, indicating that the message is a termination/balance notification and the payload includes the balance amount, machine identifiers, and other locating/tracking information.

Step 238 includes sending the termination/balance notification, from API server 130 to CMT 110.

In an alternative embodiment, at step 240, the mobile device may optionally generate the termination/balance notification. For example, the UI on mobile device 120 may include a ‘terminate account’ active icon, and activating the icon results in generating a termination/balance notification.

Step 242 includes optionally sending the termination/balance notification from mobile device 120 to CMT 110. Step 242 is dependent on the mobile device being configured to generate the termination/balance notification. For example, step 242 only occurs if the optional step 240 occurs.

Step 244 includes receiving the termination/balance notification at CMT 110.

The receipt of the notification acts as a trigger to start step 246.

Step 246 includes generating, at CMT 110, an account balance and an update for the merchant/catalogue account based on the termination/balance notification.

Step 248 includes optionally sending the update generated in step 246 from CMT 110 to mobile device 120. Step 248 is dependent on the account balance generated in step 246. For example, when a transaction at the API server 130 results neither an increase or a decrease to the merchant account or the user account (e.g., video made of a product, but no purchase made), then step 248 would not need to send an update to the financial account displayed on mobile device 120.

Step 250 includes generating a write/store notification. For example, CMT 110 may generate a signal that includes a packet of information to be printed on receipt 160, or to be written in a virtual address location. Information to be printed or stored includes merchant establishment identifiers, transaction identifiers, validation identifiers and confirmation codes, transaction types, transaction amounts, dates, and time, duration or deadlines for future transactions (e.g., termination credit valid until the end of the month), manufacture identifiers, and a product or consumable content identifier. The merchant establish identifiers include address and phone number. The transaction identifiers, validation identifiers, and confirmation codes include numeric sequences, alphanumeric sequences, or hashtags associated with the transaction, validation, or confirmation code. The transaction types include termination and balance. The product or consumable content identifier includes a two-dimensional barcode, a QR code, a product type code (e.g., 1=video file, 2=audio file, and 3=image file), or combinations thereof.

In an alternative embodiment, step 252 includes optionally using the API server 130 to generate the write/storage notification for the content writer.

Step 254 includes sending, from CMT 110, the write/storage notification to content writer 140.

Step 256 includes optionally sending, from API server 130 the write/store notification to content writer 140. Step 256 depends on the API device being configured to generate the write/store notification, as discussed in step 252.

Step 258 includes receiving the write/store notification. The receipt of the notification acts as a trigger to activate the content writer, which previously was in a sleep mode or a state of low activity.

Step 260 includes using the information from the write/store notification to write to and store a physical and/or virtual receipt. For example, content writer 140 may create a cache entry for receipt 160 in a circular last-in-first-out buffer. The a database connected to the buffer includes a content reader having a pointer disposed prior to a pointer of the content writer to read the information printed in entry/receipt 160, or from any other receipt/entry in the buffer. The content reader may also read information from the writer substantially simultaneous with the content being written.

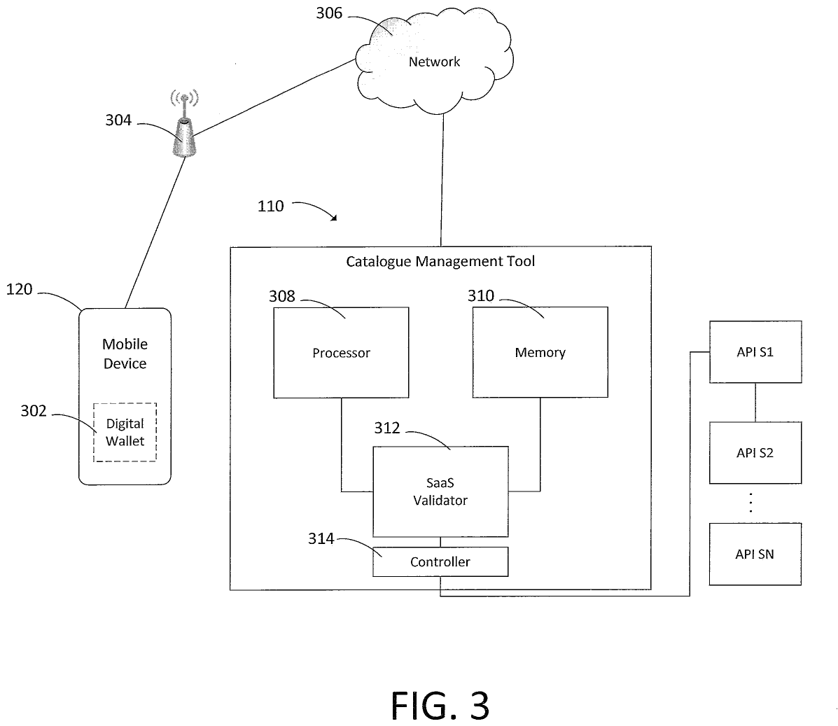

Referring now also to FIG. 3 in the drawings, an embodiment of CMT 110 is illustrated. The CMT 110 is connected with digital wallet 302 of mobile device 120 through a base station or wireless access point 304 and mobile or wireless network 306. The CMT includes processor 308 connected with memory 310 and KBS validator 312. Controller 314 is connected to KBS validator 312, processor 308, memory 310, and multiple API devices or servers. Controller 314 communicates control commands between one or more network nodes of the catalogue network. For example, controller 314 communicates control commands to update a financial account on mobile device 120. By way of another example, controller 314 communicates control commands to one or more client API devices, such as those manufactured, operated, or controlled by Amazon or Ebay.

The KBS validator 312 is tasked with ensuring valid financial transactions occur using generally accepted accounting principles (GAAP). For example, a user may attempt to purchase $100 worth of product, but may actually only have $50 in their digital wallet. KBS validator 312 would prevent the transaction from occurring unless there were another source of funds within the digital wallet. The KBS validator 312 may also be configured to ensure a valid/active software license has been purchased or is up-to-date.

Under the preferred embodiment, the digital wallet 302 is configured to allow a multitude of transactional options. The options include, but are not limited to, a user being able to directly send payment to a consumable content provider, a user being able to divide their payments with another user of the system, and a user being able to conduct transactions directly with another individual user. While the above description provides options for the digital wallet under the preferred embodiment, it should be appreciated that alternative embodiments may include fewer wallet options or additional wallet options. The digital wallet may have the option for a user to store their payment data, such that reentry of payment data is not necessary every time a transaction is to be conducted. Beyond payment options, an additional option of delivery may be associated with the digital wallet. For example a delivery can be sent to a different location than the billing location of the purchasing user, such as delivery of a gift. Additionally, if a purchase includes multiple deliverable pieces, a user may select multiple delivery locations for the different pieces. As a whole, the digital wallet being included with the four-dimensional e-commerce and interconnectivity system allows for a unique social commerce setting unlike any other current form of commerce or social networking.

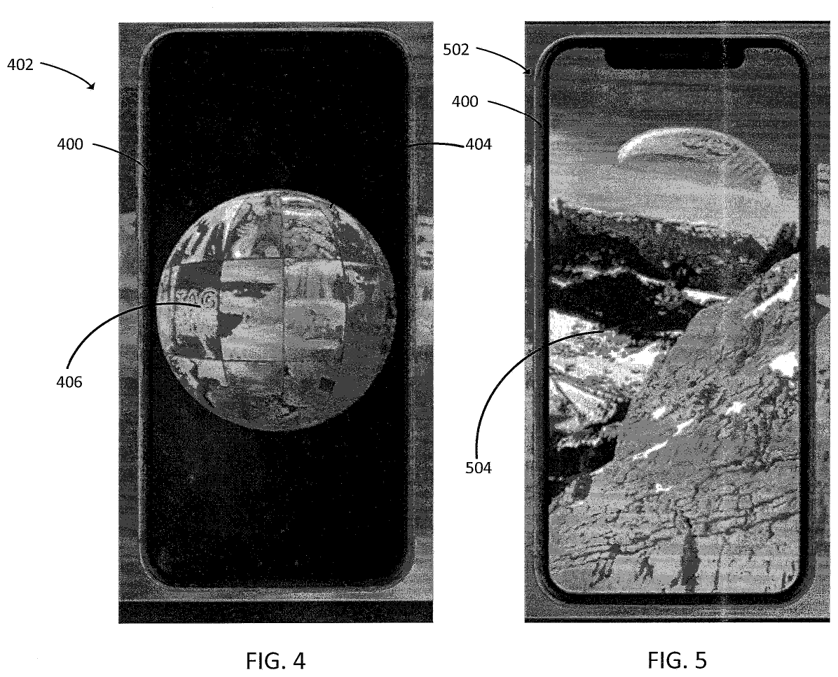

Referring now also to FIG. 4 in the drawings, a mobile device 400 displays user interface 402, including an interactive spherical icon 404. The spherical icon 404 includes multiple interactive elements 406 displayed with a precise shape and at precise coordinates (r, Θ, ϕ) to ensure the display of the multiple interactive elements 406 maintains the appearance of a sphere. For example, the edges of an interactive element 406 are displayed as rectangles having bowed latitude and longitude lines. Alternatively, any circular, square, curved, symmetrical, or non-symmetrical shape may be tessellated together to form the spherical shape of the interactive spherical icon 404. While it is preferred that the interactive icon is spherical, it should be appreciated that alternative embodiments of the interactive icon may take on other shapes. For example the interactive icon may any polyhedron, such as a cube or some form of prism, or it could be a more traditional curved shape, such as a cylinder or cone. Most embodiments of the interactive icon, preferred or alternative, will have some sort of external surface, whether it be curved or planar.

Referring now also to FIG. 5 in the drawings, an interactive element 406 is manipulated or touched, such that a new user interface 502 is rendered and is displayed. The new user interface 502 includes consumable content 504, such as a video file, displayed on the mobile device. Under the preferred embodiment, consumable content 504 is presented to a user based off of that individual user's behavioral data, such as their likes and searches. By using the consumer's behavioral data, the content delivery is optimized. However, alternative embodiments of the system may present consumable content to a multitude of users in an identical manner.

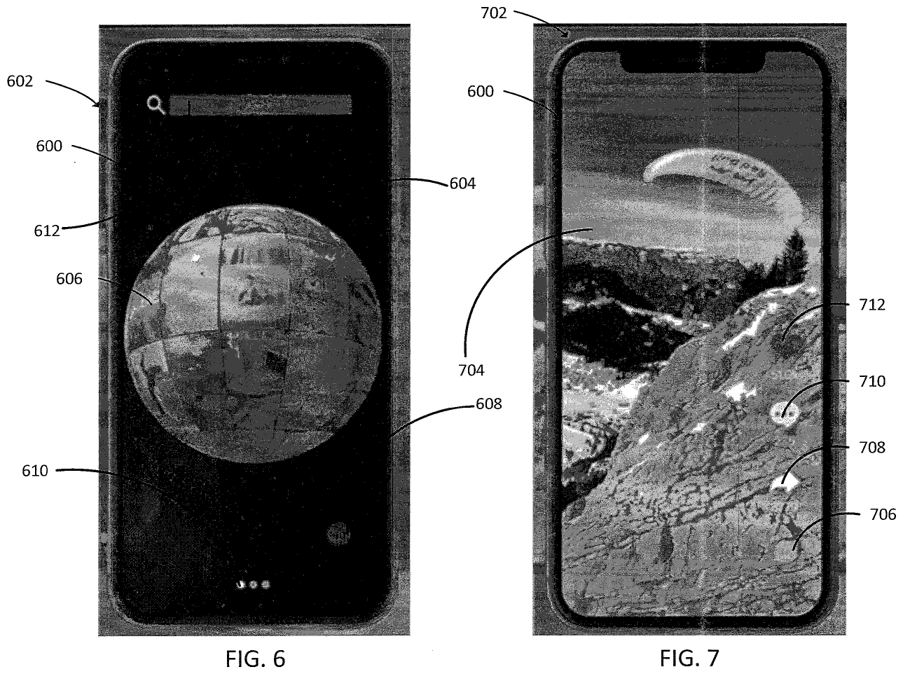

Referring now also to FIG. 6 in the drawings, a mobile device 600 displays user interface 602 including an interactive spherical icon 604. The spherical icon 604 includes multiple interactive elements 606 displayed with a precise shape and at precise coordinates (latitude, longitude, size/shape) to ensure the display of the multiple interactive elements 606 maintains the appearance of a sphere. For example, the edges of an interactive element 606 are displayed as polygons having bowed arc boundary lines. Alternatively, any circular, square, curved, symmetrical, or non-symmetrical shape may be tessellated together to form the spherical shape of the interactive spherical icon 604. The user interface 602 further includes a connection status icon 608, a depth/level/page indicator icon 610, a search bar 612, and other similar interactive icons.

In an alternative embodiment, an altered reality device, such as a virtual reality headset or augmented reality headset, may be used, such that the interactive icon is presented in a different manner than a four dimensional icon on a two dimensional surface. While using a virtual reality headset, a user may have the interactive icon appear all around them, such that the appearance is that the user is located within the sphere. While “inside” the sphere, a user may interact with the surrounding icon by moving around and pointing to pieces of content. While using an augmented reality headset, the interactive icon may appear as if it is placed directly in front of the user, such that the user can reach out and interact with the icon by rotating it or selecting pieces of content. Each alternative embodiment using an altered reality device may include some level of filtering ability, where a user can control what exactly is being shown and how the content is being presented.

Referring now also to FIG. 7 in the drawings, interactive element 606 is manipulated or touched, such that a new user interface 702 is rendered and is displayed. The new user interface 702 includes consumable content 704, such as a video file, displayed on the mobile device, and additional status icons. For example, a status icon 706, such as Internet connection status, a public status icon 708, including a share feature as well as a number of times the consumable content has been shared, a personal status or comment icon 710, and a “like” or “preference” icon 712. It should be appreciated that other interactive features may be included either in addition to those mentioned, or in place of those mentioned.

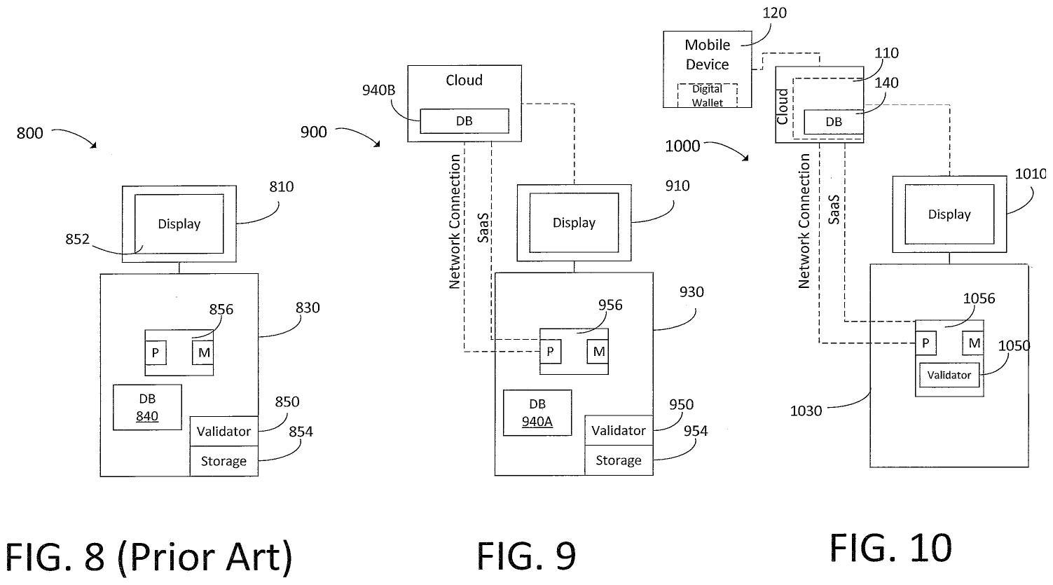

Referring now also to FIG. 8 in the drawings, prior art catalogue management and server sub-system 800 is illustrated. Prior art sub-system 800 includes prior art CMT 810 and prior art API device 830. The prior art CMT 810 includes a local content writer/database 840, a validator 850, display 852, a physical receipt or transaction storage container 854, and SAS client board 856, such as a point-of-sale interface board (POS). Sub-system 800 uses a local software and accounting system, where receipts and transactions are stored in local storage containers relative to the API device 830 and CMT device 810. The bulkiness of the prior art sub-system 800 device is due, at least in part, to the unnecessary local content writer/database 840, validator 850, and physical receipt storage bins 854.

Referring now also to FIGS. 9 and 10 in the drawings, a block diagram of prior art sub-system 800 is illustrated relative to catalogue sub-systems 900, 1000 of FIG. 9 and FIG. 10 in order to describe features of the present application.

Referring now also to FIG. 9 in the drawings, catalogue sub-system 900 includes CMT 910 and API device 930. Although the API device 930 includes a local content writer/database 940A, it also is configured to communicate with and store data on remote database 940B. The sub-system 940 further includes a validator 950, display 952, a physical receipt or transaction storage container 954, and SAS client board 956, such as a point-of-sale interface board (POS). Sub-system 900 is connected to communicate with a remote content writer associated with database 940B over a first, second, or third communication channel. The first communication channel connects the cloud storage and SaaS service to each physical machine and each virtual machine that presents consumable content to a customer. Typically, CMT 910 is located between the cloud storage and the POS devices of an establishment. The primary communication channel includes an Ethernet, fiber optic, or similar hardware and communication protocol. The secondary communication channel connects the cloud storage and the POS via the Ethernet protocol or via a Serial Attached SCSI (SAS) protocol. This allows API server/device 930 to have one or more backup communication channels in case the primary channel to CMT 910 is slow or interrupted.

Although FIG. 9 depicts only a single cloud database, multiple redundant storage devices are encompassed by the present invention.

Referring now also to FIG. 10 in the drawings, in an alternative embodiment catalogue sub-system 1000 includes CMT 1010 and API device 930. API device 1030 includes a validator module 1056 as a component of the CMT circuit board. Validator module 1056 is a system on chip (SOS), field programmable gate array (FPGA), or similar programmable logic module. Validator module 1056 is a backup validator in the event SaaS validator 312 (see FIG. 3) is unavailable. In this situation, the backup validator and memory of the SAS client board (SCB) are configured to process a virtual transaction from a digital wallet according to GAAP. The SCB may be configured as a single machine infinite bus (SMIB) controller.

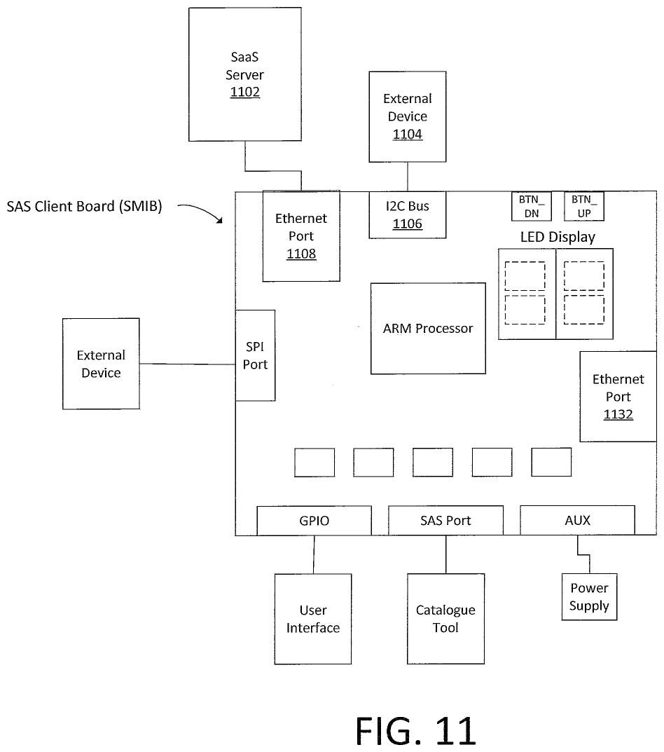

Referring now also to FIG. 11 in the drawings, SCB 1100 is illustrated. SCB 1100 is configured for API device accounting automation, user tracking, and generating merchant sales, refunds, or credits. SCB 1100 is connected to SAS server 1102, first external device 1104, second external device 1106, user interface 1108, CMT 1110, and power supply 1112. AUX port 1114 connects SCB 1100 to power supply 1112. SAS port 1116 connects the SCB to CMT 1110. General purpose input/output (GPIO) port 1118 connects the SCB to user interface 1108. Serial peripheral interconnect (SPI) port 1120 connects the SCB to the second external device 1106, such as a magnetic or RFID reader. ARM processor 1122 can be any suitable microprocessor. LED display 1124 displays messages to a customer (e.g., account balance, transaction type, etc.), or to an administrator (e.g., hexadecimal addresses). Circuit board increment button 1126 and decrement button 1128 are for pre-configuring and adjusting the circuit board settings. I2C bus 1130 connects SCB 1100 to second external device 1106, including but not limited to, memory expanders, display screen monitors, and speakers. Ethernet port 1132 connects SCB 1100 to SAS server 1102.

Power supply 1112 is typically from 4.5V to 24V. SCB 1100 receives power input to power supply 1112 from the API server device in which it is installed.

Switches and patch cords connect Ethernet port 1132 and SMIB 1100. Ethernet speeds to SCB 1100 are 10 and 100 Mbit. User datagram protocol (UDP) is used for transport layer (ISO layer 4) communications.

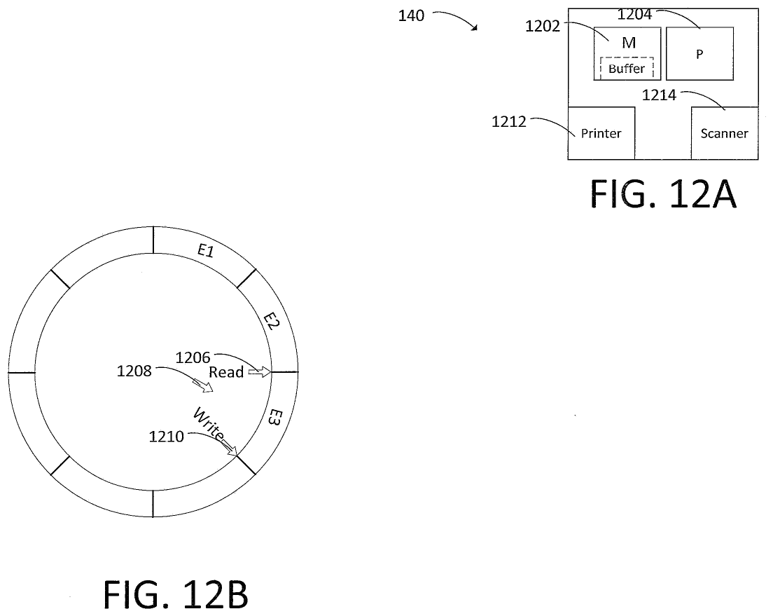

Referring now also to FIGS. 12A to 12B in the drawings, remote content writer 140 is illustrated. Remote content writer 140 includes memory 1202, a processor 1204, a first pointer 1206 connected to a second pointer 1208. Between the read/writer pointers 1206, 1208 is a locator 1206, which provides a real-time, status, locating, and tracking feature for system 100. Locator 1206 includes a stack pointer.

In at least one embodiment, locator 1206 includes a printer head, scanner, processor, and short-term memory. The remote content writer uses a ‘last in first out’ (LIFO) or ‘first in last out’ (FILO) storage model, creating an established order to the receipt and transaction storage. Short-term memory includes a buffer or a queue of receipts or virtual transaction entries to locate and read.

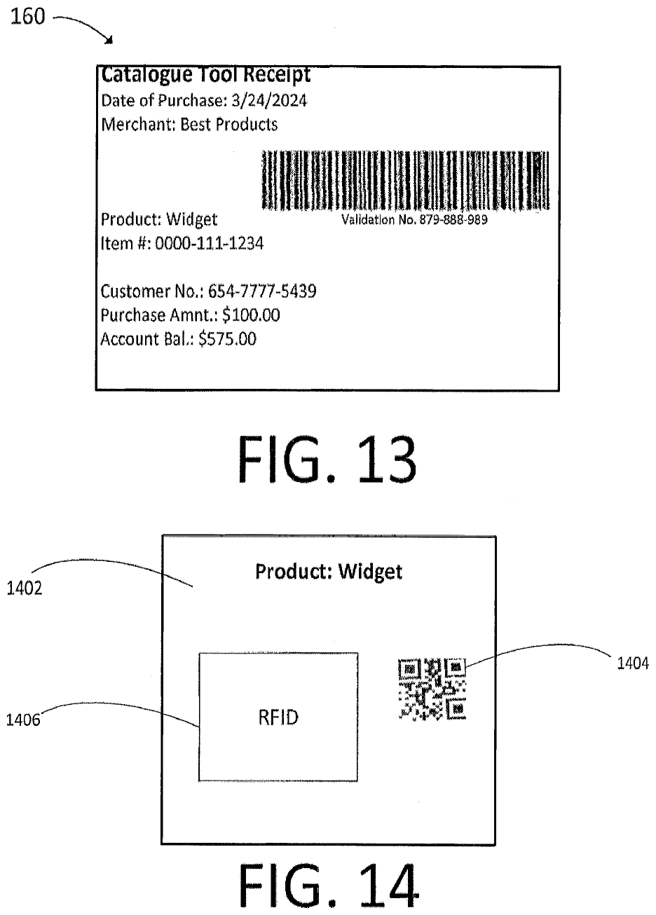

Referring now also to FIG. 13 in the drawings, an embodiment of physical receipt 160 is illustrated. It is noted that VPALs or transaction entries will include similar if not identical information. Receipt 160 is depicted having a two-dimensional image key (e.g., barcode), however, any similar image key that is quickly read may be used.

Referring now also to FIG. 14 in the drawings, product 1402 is illustrated. Product 1402 includes key image 1404 affixed to the product, such as a 3D QR code. Product 1402 includes a radio frequency identifier (RFID) tag 1206 within the device, which is associated with the merchant establishment location. Because a customer who uses their mobile device to scan key image 1404 has their location associated with a merchant location or a specific store, any financial transactions generated at that location are automatically added to the financial account of the user through the network of the merchant establishment and CMT 110. Product is displayed in The Sphere and is determined to be available for purchase using the RFID tag 1206.

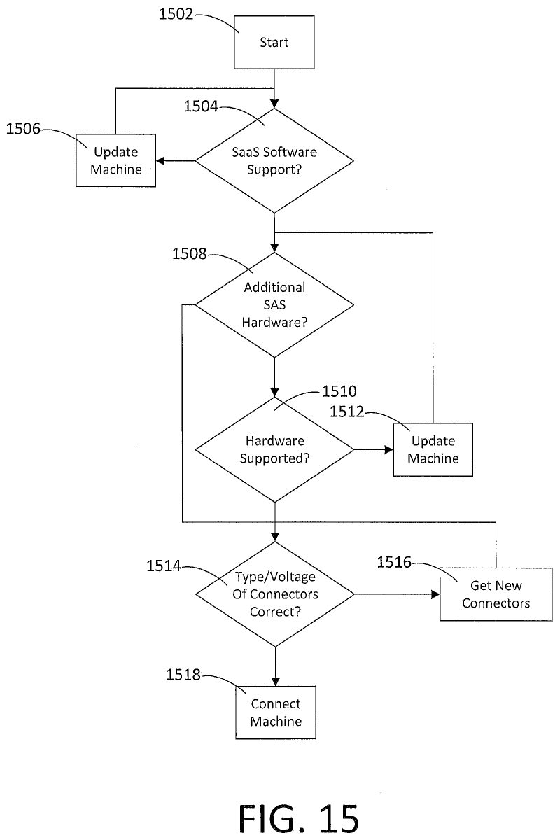

Referring now also to FIG. 15 in the drawings, method 1500 for connecting a SCB board to a networked API device is illustrated. Method 1500 starts at step 1502 by administrator providing consumable content to upload to a catalogue of the network of the merchant.

Step 1504 includes checking the consumable content for merchant establishment supported features. This includes checking for SAS supported features (e.g., is this for sale, just for viewing, copyright protected, etc.), and checking the drivers, libraries, function calls, and executable files of the API device.

Step 1506 includes determining that the API device does not have SAS supported features. Step 1506 further includes contacting the POS provider of the merchant establishment to update or reprogram the features of the POS machine and/or API device.

Returning to Step 1504, the determination is made that the API device has SAS supported features and that they are enabled. The method then proceeds to step 1508.

Step 1508 includes determining that the API device has additional hardware features installed. The additional hardware features include, but are not limited to, level shifters and optical isolators.

Step 1510 includes determining that the additional hardware features are not supported.

Step 1512 includes updating the machine to support the additional hardware features. For example, kernel code, drivers and executable files may be re-written or modified to call necessary functions and libraries. Number and data types of input may also be updated. By way of another example, object-oriented software, such as Java, or even the operating system, may be updated.

Returning to step 1510, the determination is made that the additional hardware features are supported. Method 1500 proceeds to step 1514.

Step 1514 includes determining that the type of connectors and associated voltage capacity (e.g., wire gauge) are not correct. For example, a SCB has capabilities for voltages associated with TTL signals and RS-232 RX/TX signals. Step 1514 includes checking the voltage levels of the API and/or POS device against the voltage capabilities of the SCB before porting the POS device to the API device.

Step 1516 includes obtaining the necessary equipment for making the porting connections. For example, a USB to TTL converter may be used to connect the SCB to an RS-232 port, providing a serial port connection between the POS and the SCB board. By way of another example, additional resistors may be attached to the SCB to adjust voltages to appropriate levels.

Returning to step 1514, the determination is made that the voltage and connector types are correct.

Step 1518 includes connecting the SCB board to the API device. For example, one or more of CATS, CAT6, SF-8680, SFF-8639, SFF-8681, and sideband connectors are used.

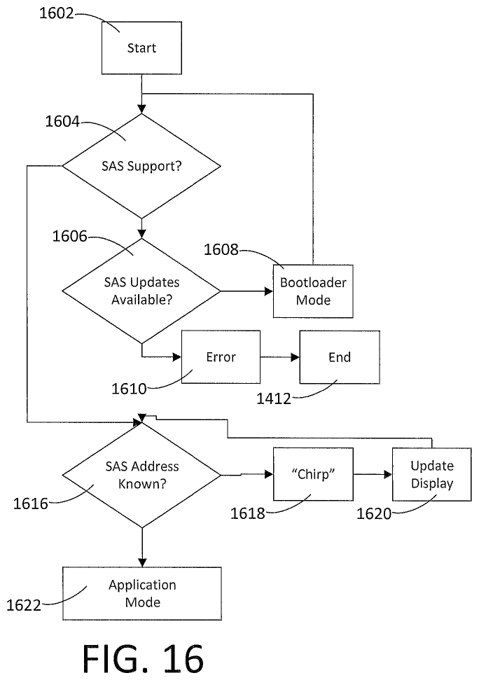

Referring now also to FIG. 16 in the drawings, a method 1600 for enabling an application mode of the API device is illustrated. Step 1602 includes starting the method by properly completing method 1500 and initiating virtual containers and kubernetes associated with the catalogue application programmable interface (API).

Step 1604 includes determining that the SAS communication is not supported or not enabled.

Step 1606 includes contacting the server and determining that there are SAS-related updates available. Step 1608 includes downloading necessary updates to the boot sector and running the machine in bootloader mode to install and restart the POS software.

Returning to step 1606, the determination is made that there are no SAS updates available. Step 1610 includes reporting an error code. Step 1612 includes ending the application mode and updating the display of the API device. For example, the display may show the following error, “Please check SAS compatibility (contact SAS provider).”

Returning to step 1604, the determination is made that the SAS features are supported and enabled for application mode. Step 1616 includes determining that the SAS address is not discovered or known.

Step 1616 includes sending a ‘chirp’ signal, or using the address of the SCB. Step 1616 includes updating the LED display of the SCB to indicate that the SCB has not obtained the hexadecimal SAS address. For example, the LED may display two dashes “- -”.

Returning to step 1616, the determination is made that the SAS address is discovered and known. Step 1616 includes updating the LED display with the hexadecimal SAS address.

Step 1620 includes enabling the application mode. The enablement of application mode enables customers to begin purchases at the API device and/or POS device.

It is noted that using the features of the present application allows for users to navigate, manipulate, interconnect, purchase, and otherwise access large quantities of consumable 4-dimensional content in a two-dimensional format. The dimensions of the four-dimensional content may include coordinates, a thumbnail image or compressed image/video file displayed relative to the coordinates, as well as the user input/manipulations allowed or associated with the consumable content. Multiple elements are displayed relative to each other to form a spherical display. The data will flow from each of the quadrants of the sphere as web service or another type of service, web, commerce, video, photo . . . each of those quadrants makes a call to a virtualized back end compute engine that accesses a data base. The interface utilizes a spherical design that moves at the control of the user and is populated by SaaS provider database, algorithm, and data.

It is noted that using the features of the present application allows merchant establishments to accurately track, store, and print important financial transactions, such as termination balances and API/POS devices associated with them. This allows the merchant establishments to compile profitable data analytics and trends, such as which API devices resulted in the highest and lowest transaction balances. Using these trends and analytics, the merchant establishment will be able to determine which navigational tools and UIs are associated with the API/POS devices producing the highest transaction balances, the time of year associated with these balances, and other important data. This enables the merchant establishment to make predictive and anticipatory changes to their API/POS machines in order to customize the e-Commerce experience and improve revenues generated.

It is further noted that using features of the present application allows merchant establishments continuous use of their API machines. Employees are not required to empty local storage bins of physical receipts, perform local backups, interrupt consuming of content, or sort memory containers. Although storage entries are generated, they are stored remotely, and in a manner that enables easy tracking and locating of specific transactions. Furthermore, the merchant API and POS machines are less bulky, resulting a more space-efficient machine.

It is further noted that embodiments of the present application use a server. In these embodiments, a server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

In some embodiments, a remote device includes a computer type user terminal device, such as a PC or tablet computer. These types of remote devices similarly include a data communication interface CPU, main memory and one or more mass storage devices for storing user data and the various executable programs.

In some embodiments, a remote device includes a mobile device type user terminal. These types of remote devices may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs.

In some embodiments, a UI includes a microphone and speaker to enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Therefore, embodiments of the methods of managing information about content transmission or data analytics outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Therefore, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the application(s), etc. shown as implemented in the drawings (see, e.g., FIG. 4). Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF), Bluetooth, and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

It is apparent that an assembly with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A system for four-dimensional e-commerce and interconnectivity, comprising:
a mobile device;
an API server;
a catalogue management tool; and
a database;
wherein the mobile device has a user interface configured to present consumable content having at least four dimensions on a display having two dimensions; and
wherein the user interface includes an interactive spherical icon associated with the consumable content.

2. The system of claim 1, further comprising:
a digital wallet;
wherein a payment to a consumable content provider can be made directly from the digital wallet.

3. The system of claim 2, wherein a user has an option to divide a payment with at least one other user of the catalogue management tool.

4. The system of claim 2, wherein a user may make a payment directly to another individual user of the catalogue management tool.

5. The system of claim 1, wherein the consumable content is presented differently to each user of the catalogue management tool, based off of the individual user's behavioral data.

6. A system for four-dimensional e-commerce and interconnectivity, comprising:
a mobile device;
an API server;
a catalogue management tool; and
a database;
wherein the mobile device has a user interface configured to present consumable content having at least four dimensions of user interactivity on a display having two dimensions;
wherein the user interface includes at least one interactive icon associated with the consumable content; and
wherein the at least one interactive icon has at least one external surface.

7. The system of claim 6, wherein the at least one external surface has a curved surface.

8. The system of claim 6, wherein the at least one external surface has a planar surface.

9. The system of claim 6, further comprising:
a digital payment system;
wherein the digital payment system stores a user's preferred method of payment, such that transactions are made without reentry of data.

10. The system of claim 9, wherein a user of the catalogue management tool has an option to conduct transactions directly with a consumable content provider or with another individual user of the catalogue management tool.

11. A system for four-dimensional e-commerce and interconnectivity, comprising:
an API server;
a catalogue management tool;
a database; and
an altered reality device;
wherein the altered reality device has a user interface configured to present consumable content having at least four dimensions of user interactivity; and
wherein the user interface has at least one interactive icon associated with the consumable content.

12. The system of claim 11, wherein the altered reality device is a virtual reality device;
wherein the user interface displays the at least one interactive icon around a user in a virtual reality setting, such that a user of the virtual reality device may look around and see the at least one interactive icon as a selectable icon.

13. The system of claim 11, wherein the altered reality device is an augmented reality device;
wherein the augmented reality device displays the at least one interactive icon, such that a user of the augmented reality device can maneuver the at least one interactive icon in planes of latitude and longitude.

14. The system of claim 11, further comprising a digital wallet.

15. The system of claim 11, wherein the at least one interactive icon comprises at least one external surface, the at least one external surface having either a curved or planar shape.
